(19) United States
(12) Patent Application Publication
(10) Pub. No.: US 2019/0266898 A1
(43) Pub. Date: Aug. 29, 2019

(54) SYSTEM AND METHOD FOR MANAGING TRAFFIC FLOW OF ONE OR MORE UNMANNED AERIAL VEHICLES

(71) Applicant: Walmart Apollo, LLC, Bentonville, AR (US)

(72) Inventors: Robert CANTRELL, Herndon, VA (US); John J. O'BRIEN, Farmington, AR (US); Brian MCHALE, Oldham (GB)

(73) Assignee: Walmart Apollo, LLC, Bentonville, AR (US)

(21) Appl. No.: 16/287,097

(22) Filed: Feb. 27, 2019

Related U.S. Application Data
(60) Provisional application No. 62/636,682, filed on Feb. 28, 2018.

(51) Int. Cl. G08G 5/00; G05D 1/10; G01S 17/93; G01S 17/66; G06F 16/909; B64C 39/02

(52) U.S. Cl. CPC G08G 5/006; G05D 1/104; G08G 5/0069; B64C 2201/127; G01S 17/66; G06F 16/909; B64C 39/024; G01S 17/933

(57) ABSTRACT

Systems, methods and devices for managing traffic one or more unmanned aerial vehicles (UAVs). The system can comprise a first UAV including a processor, a memory and one or more sensors each in communication with the processor. The sensors can be configured to detect a secondary unmanned aerial vehicle approaching said primary unmanned aerial vehicle within a predetermined distance, and to create an area entirely surrounding the primary unmanned aerial vehicle that said secondary unmanned aerial vehicle is prohibiting from entering based on said one or more sensors. The processor can be capable of determining a route of said primary unmanned aerial vehicle to a geographical location based on a signal received from the one or more sensors that enters said area entirely surrounding primary unmanned aerial vehicle.

### PRIORITY

This application claims priority to U.S. Provisional Application No. 62/636,682, filed Feb. 28, 2018, the contents of which are incorporated herein in their entirety.

### BACKGROUND

### 1. Technical Field

The present disclosure generally relates to systems and methods for managing traffic flow of one or more unmanned aerial vehicles, and more specifically, doing so independently and without the assistance of a central server.

### 2. Introduction

Typically, a central server is in communication with each of one or more unmanned aerial vehicles (UAVs). Accordingly, in operation, the central server will determine an appropriate route for each UAV. Thereafter, the central server will continually monitor a location of each UAV, and will determine appropriate maneuvering in route to a delivery destination. As a result, this can be very strenuous on the central server. The central server is required to handle the traffic flow of all UAVs. In doing so, the central server must make an unlimited amount of decisions for each UAV at any given point in time. Along these lines, the central server may not sufficiently flexible and/or powerful to handle such an infinite number of possibilities and complex situations. Thus, instructions to the UAVs are delayed and possibly incorrect. Embodiments of the present inventions solve these problems and, thereby, amongst other things, provide a more efficient and flexible manner for handling traffic flow of UAVs. Decision making is distributed from the central server to the processors on the UAVs, thereby freeing up the central server to more quickly attend to other tasks, and allowing the processors on the UAVs to more quickly control their own actions.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media a technical solution to the technical problem described. In an embodiment of the present invention, a primary unmanned aerial vehicle for managing traffic flow is provided, including: a processor; a memory in communication with the processor; and one or more sensors in communication with the processor and the memory, wherein the one or more sensors detect a secondary unmanned aerial vehicle approaching the primary unmanned aerial vehicle within a predetermined distance, wherein the one or more sensors create an area of coverage entirely surrounding the primary unmanned aerial vehicle that the secondary unmanned aerial vehicle is prohibiting from entering, and wherein the processor determines a route of the primary unmanned aerial vehicle to a geographical location based on a signal received from the one or more sensors that enters the area of coverage entirely surrounding primary unmanned aerial vehicle.

In another embodiment of the present invention, a method of managing traffic flow of one or more unmanned aerial vehicles is provided, including: receiving, by a primary unmanned aerial vehicle, a first location for travel; determining, by the primary unmanned aerial vehicle, an area of coverage entirely surrounding the primary unmanned aerial vehicle that a secondary unmanned aerial vehicle is prohibited from entering, the area of coverage determined using one or more sensors of the primary unmanned aerial vehicle; and determining by the primary unmanned aerial vehicle, a modified route for the primary unmanned aerial vehicle based on a signal received from the one or more sensors that the secondary unmanned vehicle has entered the area of coverage entirely surrounding primary unmanned aerial vehicle.

In yet another embodiment of the present invention, a system for managing traffic flow is provided, and can include: a first unmanned aerial vehicle comprised of: a processor, a memory in communication with the processor, and one or more sensors in communication with the processor and the memory, wherein the one or more sensors detect a secondary unmanned aerial vehicle approaching the primary unmanned aerial vehicle when the secondary unmanned aerial vehicle is within a predetermined distance of the primary unmanned aerial vehicle, wherein the one or more sensors create an area entirely surrounding the primary unmanned aerial vehicle that the secondary unmanned aerial vehicle is prohibiting from entering, and wherein the processor determines a route of the primary unmanned aerial vehicle to a geographical location based on a signal received from the one or more sensors, the signal indicating that the secondary unmanned aerial vehicle is entering the area entirely surrounding primary unmanned aerial vehicle.

### BRIEF DESCRIPTION OF THE DRAWINGS

FIG. 1 illustrates an exemplary system comprising a plurality of an unmanned aerial vehicles in accordance with embodiments of the present invention;

FIG. 2 illustrates a schematic diagram of an exemplary unmanned aerial vehicle in accordance with embodiments of the present invention;

FIG. 3 illustrates an exemplary sensor utilized on an unmanned aerial vehicle in accordance with embodiments of the present invention;

FIGS. 4, 5, and 6 respectively illustrate an exemplary boundary surrounding an unmanned aerial vehicle utilizing one or more of the sensors illustrated in FIG. 3 in accordance with embodiments of the present invention;

FIG. 7 illustrates an exemplary plurality of unmanned aerial vehicles managing traffic in accordance with embodiments of the present invention;

FIG. 8 illustrates an exemplary plurality of unmanned aerial vehicles managing traffic in a swarm in accordance with embodiments of the present invention;

FIG. 9 illustrates a method for managing traffic of one or more unmanned aerial vehicles in accordance with embodiments of the present invention; and

FIG. 10 illustrates an exemplary computer system in accordance with embodiment of the present invention.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure. It is also important to note that any reference in the specification to “one embodiment,” “an embodiment” or “an alternative embodiment” means that a particular feature, structure or characteristic described in connection with the embodiment is included in at least one embodiment of the invention. As such, the recitation of “in one embodiment” and the like throughout the specification does not necessarily refer to the same embodiment.

The systems and methods disclosed herein are managing traffic flow of one or more unmanned aerial vehicles (UAVs). The traffic flow the unmanned aerial vehicle can be managed when in flight or while being maneuvered on-ground. As will be discussed in more detail below, although the unmanned aerial vehicles may be in communication with a central server, the unmanned aerial vehicles may manage traffic independently from the central server and without assistance of the central server.

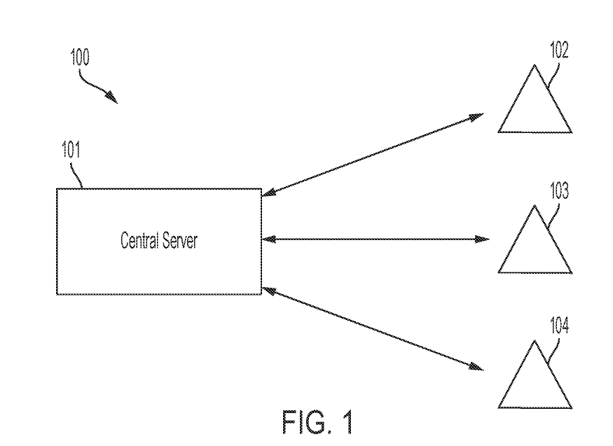

Referring now to the figures, various embodiments of systems and methods for managing traffic flow of one or more UAVs will be disclosed. Referring now to FIG. 1, an exemplary system 100 is described. The system 100 can include a central server 101 and one or more UAVs 102-104. Alternatively, although not illustrated, the system 100 can include one or more UAVs 102-104. However, the central server 101 can be located in a distribution center and/or a local store. Along these lines, regardless of its location, the central server 101 can act on behalf of one or more local stores and/or one or more distribution centers. The central server 101 can transmit data to the UAVs 102-105, including, for example, a delivery location, a product to be delivered, and a path for delivery to the delivery location. According to an embodiment, the path of delivery to the delivery location can be based on one or more properties of a product to be delivered and/or a delivery location. Properties of the product can include a weight, a size, and an expiration date. Properties of the delivery location can include a type of delivery location (i.e., mailbox, commercial building, residential building, etc.), hours of operation, and a distance from the starting point of the UAV.

As such, at a minimum, the central server 101 can transmit a destination or task, such as a delivery location to the UAVs 102-104. Upon receiving the delivery locations, the UAVs 102-104 can travel to the delivery location. In traveling to the delivery location, the UAVs 102-104 can have one or more maneuvering capabilities and/or navigation rules, as will be discussed in more detail below, to not collide with each other. The capabilities and/or rules can be pre-loaded onto the UAVs 102-104 by an external device, which may or may not be the central server 101.

Accordingly, as mentioned above, the UAVs 102-104 can each act independently from one another and the central server 101 in determining an efficient route to the delivery locations or for performing the assigned task. As such, the central server 101 does not need to make appropriate determinations for the UAVs 102-104 while they travel to the delivery locations. However, the central server 101 can serve as a backup in case one of the UAVs 102-104 is unable to make an appropriate determination when traveling to the delivery location. Moreover, the central server can work in parallel with the UAV to provide control, and to ensure appropriate determinations.

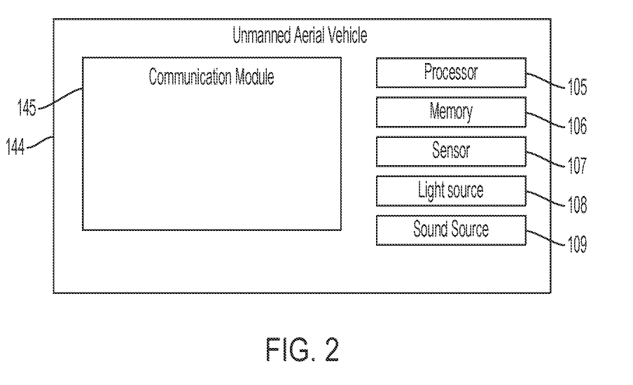

Referring now to FIG. 2, an exemplary UAV 144 that can be utilized in the system 100 of FIG. 1 is illustrated. The UAV 144 can include a communication module 145 to communicate with the central server 101 (illustrated in FIG. 1), as discussed above, and/or to communicate with one or more other UAVs, as will be discussed below. Moreover, the UAV 144 can include a processor 105, a memory storage device 106 in communication with the processor 105, and one or more sensors 107 in communication with the processor 105 and memory storage device 106. The one or more sensors 107 can include a light sensor and/or a sound sensor. The light sensor can detect a wavelength of light from another UAV, and the sound sensor can detect a wavelength of sound from another UAV.

According to an embodiment, the sensors 107 of the UAV 144 can include a light sensor capable of detecting a light emitting from another object. The light sensor can reflect an area that another object cannot enter. As such, the light sensor can detect ranges of intensity of light. To do so, the light sensor can detect one or more properties of light, including dispersed lighting, light intensity, and apparent size of light, sensitivity of light, pulse of light. The properties can be representative of whether an object is approaching or retreating the UAV 144. For example, an increase of light, and/or of apparent size of light, can represent an object approaching. Along these lines, a decrease of light intensity, and/or of apparent size of light, can represent an object retreating.

To determine properties of an object, the light sensor can be configured to detect light within one of a plurality predetermined spectrums or wavelength ranges. The predetermined wavelength ranges can be detectable to a human eye. As such, the predetermined wavelength ranges can be between about 390 nm (nanometers) and about 700 nm. Alternatively, or in addition, the predetermined range can be undetectable to the human eye. As such, the predetermined wavelength ranges can be less than about 390 nm and greater than about 700 nm. For instance, the predetermined wavelength range can be between about 250 nm and 1200 nm.

Along these lines, the light sensor can detect light having different predetermined wavelength ranges which representing different colors. For instance, the light sensor can detect light having a wavelength between about 380 nm and about 450 nm (representing the color violet), a wavelength between about 450 nm and about 495 nm (representing the color blue), a wavelength between about 495 nm and about 570 nm (representing the color green), a wavelength between about 570 nm and about 590 nm (representing the color yellow), a wavelength between about 590 nm and about 133 nm (representing the color orange), and a wavelength between about 133 nm and about 750 nm (representing the color red).

Still referring to FIG. 2, according to an embodiment, the sensors 107 can include a sound sensor configured to detect a sound. To do so, the sound sensor can be configured to detect a sound within one of a plurality of predetermined ranges. The predetermined ranges can be detectable to a human's hearing. For example, the predetermined range can be between about 20 hertz (HZ) and about 20 kilohertz (kHz). Alternatively, or in addition, the predetermined ranges can be undetectable to a human's hearing. For example, the predetermined range can between less than 20 HZ and greater than 20 kHz. As such, the predetermined ranges can include ultrasonic waves (greater than 20 kHz). According to an embodiment, the predetermined ranges of sound do not affect wildlife, and/or are undetectable to wildlife.

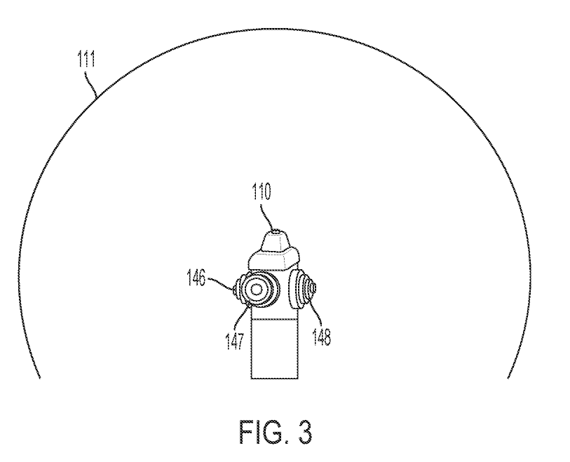

Referring now to FIG. 3, an exemplary sensor 110 that can be utilized on the UAV 144 (illustrated in FIG. 2) is depicted. The sensor 110 can include one or more sensing portions 146-148. The sensing portions 146-148 can create an area of coverage 111 surrounding at least a portion of the sensor 110, or entirely surrounding the sensor 110, that can detect a signal from another object. The area of coverage can relate to a space that another object cannot enter relative to the UAV 144. In response to an object approaching the UAV 144, the UAV 144 and/or the approach object can make an appropriate maneuver relative to the other.

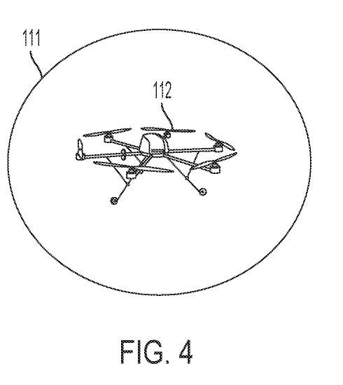

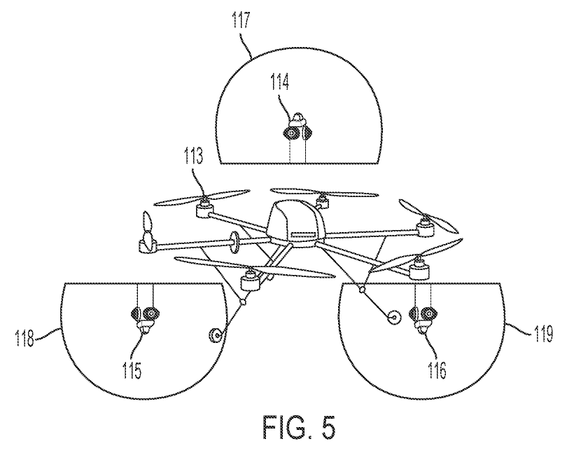

As illustrated in FIG. 4, an area of coverage 111 created by the sensor 110 (shown in FIG. 3) can entirely surround a UAV 112, and thus, can emulate a 360° bubble entirely surrounding the UAV 112. Alternatively, as will be described in more detail in relation to FIG. 5, the sensor 110 can only partially surround a UAV. In creating the area of coverage 111, the sensor 110 can determine a trajectory of light being transmitted by another object. For instance, the sensor 110 can determine a precise location of an object relative to the UAV 144.

Along these lines, a size of the area of coverage 111 surrounding at least a portion of the sensor 110 can be based on the equation of I∝1/d², wherein “I” represents intensity of the light that can be detected by the sensor, “d” represents the distance of coverage surrounding the sensor 110, and ∝ indicates that I is directly proportional to 1/d². Moreover, the size of the area of coverage can be dynamically adjusted based on one or more properties of the UAV 112 and/or another object. The properties of the UAV 112 can include a speed of the UAV, an expected speed of another object, and an expected number of other objects within a vicinity of the UAV (e.g., 100 feet, 250 feet, or 500 feet). Moreover, the size of the area of coverage 111 can correlate to the wavelength that the sensor 110 is to detect.

Referring now to FIG. 5, an exemplary UAV 113 having a plurality of sensors 114-116 that create a plurality of respective areas of coverage 117-119 for detecting a signal from an object is shown. The sensors can be placed on any location on the UAV 113. For instance, as shown, the sensors 114-116 can be placed a specific distance away from the center of the UAV 113. This can ensure maximum coverage for detecting a signal from an object. As such, the sensors 114-116 can be located on or about a piece of the body of the UAV 113 that extends away from the center of the UAV 114, such as the portion of the body that holds the propellers.

Moreover, the sensors 114-116 can be located on a top, bottom and/or side portion of the UAV 113. As illustrated, one sensor 114 can be located on a top portion of the UAV 113, and two sensors 115, 116 can be located on bottom portions of the UAV 113. Along these lines, the sensors 114-116 can be located on angle on any portion of the UAV 113. Moreover, the sensors 114-116 can be configured to rotate. For instance, the sensors 114-116 can be configured to be directed toward a location that the UAV 113 is traveling. By having the sensors 114-116 located at various portions of the UAV 113 and/or being rotatable, the sensors 114-116 can be capable of covering all portions of the UAV 113.

Furthermore, the areas of coverage 117-119 of the sensors 114-116 can cover only a portion of the UAV 113, or can cover the entire UAV 113. Along these lines, the areas of coverage 117-119 can be mutually exclusive or inclusive. According to an embodiment, when the sensors 114-116 are located on portions of the UAV 113 that extend away from the center of the UAV 113, a portion of the center of the UAV 120 may not have areas of coverage 121-123.

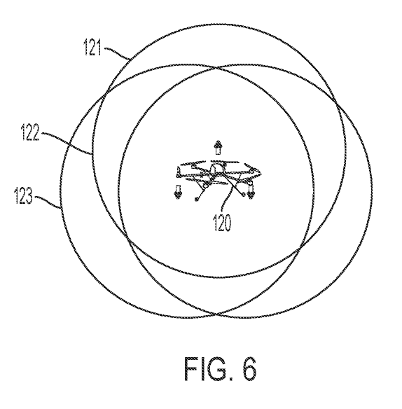

Referring now to FIG. 6, exemplary areas of coverage 121-123 of multiple sensors (not depicted) for a UAV 120 is illustrated. As discussed previously, the areas of coverage 121-123 can be mutually inclusive. According to an embodiment, at least two of the areas of coverage 121-123 can partially overlap. According to another embodiment, as illustrated, each of the three areas of coverage 121-123 can partially overlap. By overlapping coverage, the UAV 120 can have an area of coverage for the UAV 120 greater than each of the areas of coverage 121-123.

Referring back to FIG. 2, as discussed above, the sensor 107 of the UAV 144 can be configured to detect a wavelength of sound, and/or to detect a wavelength of light. Likewise, the UAV 144 can also include a light source 108 and/or a sound source 109, each of which can be in communication with the processor 105. The light source 108 can transmit a wavelength of light, and the sound source 109 can transmit a wavelength of sound. As such, the light source 108 and/or sound source 109 can be utilized to ensure that the UAV 144 does not enter an area of coverage provided by one or more sensors of another object (e.g., another UAV).

Like sensors 114-116 (illustrated in FIG. 5), the light source 108 and/or sound source 109 can be located on a top, bottom and/or side portion of the UAV 144. Also, the light source 108 and/or sound source can be place in arrangements on the UAV 144 in a similar fashion as the sensors 114 described above with respect to FIG. 5. Specifically, for example, one light source 108 and/or sound source 109 can be located on a top portion of the UAV 144, and two light sources 108 and/or sound sources 109 can be located on bottom portions of the UAV 144. Along these lines, the light source 108 and/or sound source 109 can be located on angle on any portion of the UAV 144. Moreover, the light source 108 and/or sound source 109 can be configured to rotate. For instance, the light source 108 and/or sound source 109 can be configured to be directed in a location that the UAV 144 is traveling. By being able to have light sources 108 and/or sound sources 109 at various portions of the UAV 144 and/or being rotatable, the light sources 108 and/or sound sources 109 can be capable of covering all portions of the UAV 144.

Moreover, the combination of the sensor 107 along with the light source 108 and/or sound source 109 can be utilized to allow a plurality of UAVs to communicate with each other, and/or to ensure that each of a plurality of UAVs are aware of the other's presence. Along these lines, the sensor 107 of the UAV can be configured to communication with another object within a predefined range, such as another UAV or manned aircraft. As such, the UAV 144 between the UAV and the other object cannot be interfered with, purposefully or inadvertently.

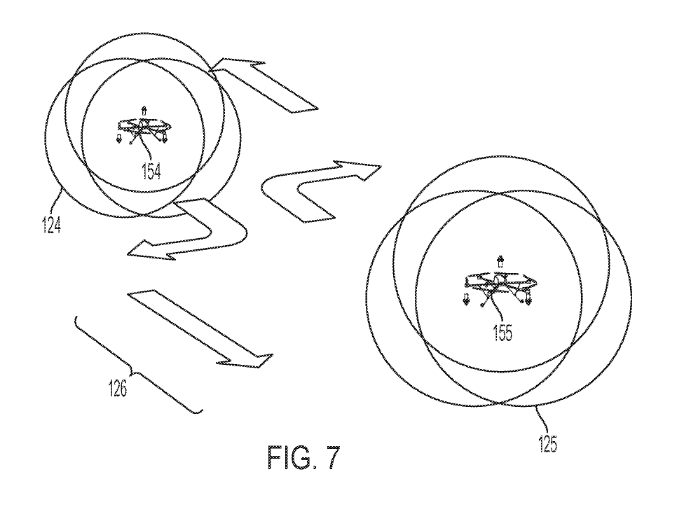

Furthermore, as mentioned above, in order for the UAV 144 to not collide with another UAV, the UAV 144 can be preloaded with one or more maneuvering capabilities and/or navigation rules. Referring now to FIG. 7, UAVs 154, 155 approaching each other is illustrated. As illustrated, the capabilities 126 of the UAVs 154, 155 can include traveling right, left, forward, or backward with respect to each other. Although not illustrated, the capabilities 126 of the UAVs 154, 155 can also be traveling upward and downward. As such, the UAVs 124, 125 can be configured to travel in any direction with respect to themselves. Furthermore, a reaction time of one of the UAVs 154, 155 may be based on a signal received from the other UAV 154, 155. The signal may be representative of a velocity and/or acceleration. The combination of the sensors and navigation rules thus define a “bubble” around the UAVs 154, 155, which the UAVs 154, 155 maintain amongst each other, and other objects. Accordingly, the UAVs 154, 155 may not enter into each other's areas of coverage as described above. Rather, the UAVs can take an appropriate maneuver to not enter each other areas of coverage.

Moreover, the navigation rules of the UAVs 154, 155 can refer to prescribed regulations for operating during traveling to a delivery destination, and/or more particularly, for acting in a particular situation in route to the delivery destination. As such, the UAVs 154-155 may not only act according to a location of an approaching object, but it may also react in accordance to a location of other objects (e.g., other UAVs). By doing so, the UAVs 154, 155 will be able to not react in a way that interferes with a route of other objects. According to an embodiment, the prescribed regulation can include one or more protocols defining the interacting between the UAVs 154. As such, the protocols can dictate which of the UAVs 154, 155 are to react/move in a particular situation. For example, if a particular UAV is carrying an important package and/or must be a delivery location at a sooner time sooner than another UAV, then such a UAV is prioritized.

Referring back to FIG. 2, as stated above, the communication module 145 of the UAV 144 can allow it receive communication of an incoming object (e.g., another drone, or a manned airplane). To receive such a notice, the UAV 144 can be in communication with separate server (e.g., central server 101 illustrated in FIG. 1) or the object itself. Upon receiving such a notice, the UAV 144 can give way to the object. Specifically, the UAV 144 can designate certain airspace to the object.

Moreover, according to an embodiment, the communication module 145 of the UAV 144 can allow it to communicate with one or more other UAVs. For instance, as illustrated in FIG. 7, when multiple UAVs 124, 125 approach each other, they can communicate who should move so that they do not collide. Moreover, the communication module 145 of the UAV 144 can allow it communicate and receive information from other UAVs, such as their delivery location, a current location, a current route, and a future maneuver. By having multiple UAVs communicating with each other, a more coordinated system can be arranged and a better understanding can be provided to the central server 101 (depicted in FIG. 1).

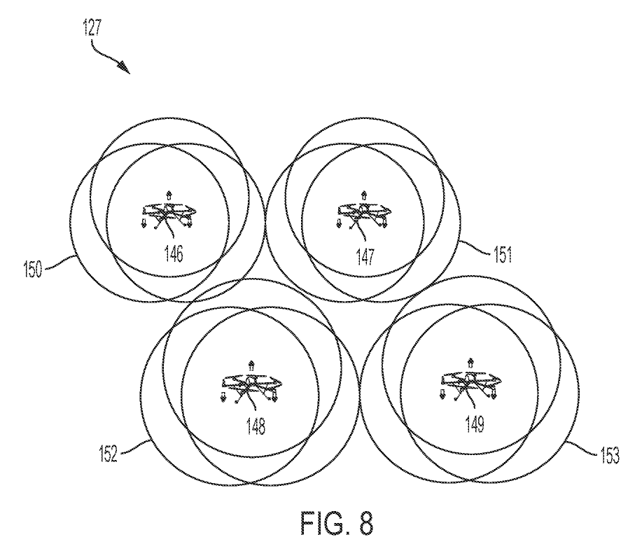

Along these lines, the communication module 145 can allow the UAV 144 to be a part of a swarm, and to communicate with other UAVs in the swarm. Referring now to FIG. 8, an exemplary swarm 127 of a plurality of UAVs 146-149 is illustrated. Each of the UAVs 146-149 of the swarm 127 can be in communication with each other. By being in communication, the UAVs 146-149 can share a route, and can jointly make appropriate steering maneuvers. In doing so, the UAVs 146-149 can make appropriate steering maneuvers at a same point in time, and can do so without separating from each other.

Furthermore, while traveling together in the swarm 127, each of the UAVs 146-149 can employ one or more areas of coverage 150-153 for detecting a wavelength of sound and/or light dependent on a number of sensors employed. For instance, as illustrated, each UAV 146-149 can employ a plurality of sensors which can have different areas of coverage. By employing areas of coverage 150-153, when traveling and making various steering maneuvers, the UAVs 146-149 can ensure that each other does not travel within a restricted boundary. Additionally, although not illustrated, the swarm 127 can have a cumulative area of coverage encompassing each of the individual areas of coverage 150-153 of the UAVs 146-149. The cumulative area of coverage can represent airspace which no other objects have permission to enter.

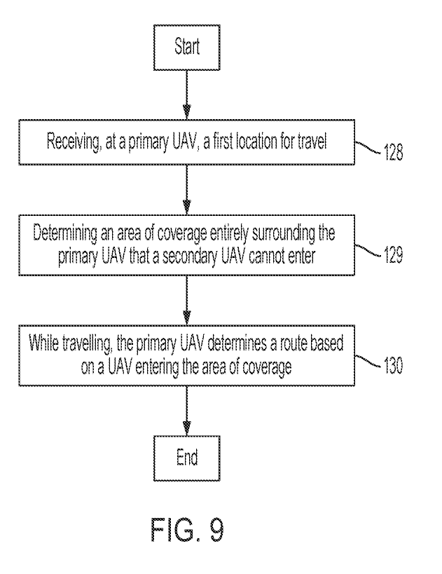

Referring now to FIG. 9, a method a method for managing traffic of one or more UAVs is illustrated. First, at step 128, a primary UAV receives a first location for travel. Thereafter, at step 129, the primary UAV determines an area of coverage entirely surrounding the primary UAV that a secondary UAV cannot enter. The area of coverage is based on one or more sensors of the primary UAV. Thereafter, at step 130, when traveling, the primary UAV determines a route based on a signal received from its one or more sensors that enters the area of coverage entirely surrounding the primary UAV. The route can be also based on one or more rules navigational rules stored within memory of the primary UAV. Each of the aforementioned steps can be performed in accordance with embodiments of the present invention as described above.

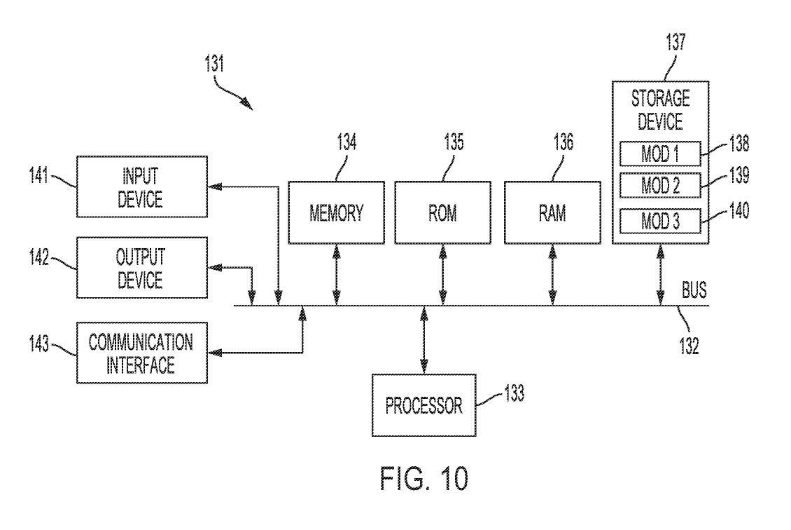

Referring now to FIG. 10, an exemplary system 131 for present invention is illustrated. The system 131 can include a general-purpose computing device, and can include a processing unit (CPU or processor) 133 and a system bus 132 that couples various system components including the system memory 134 such as read-only memory (ROM) 135 and random access memory (RAM) 136 to the processor 133. The system 131 can include a cache of high-speed memory connected directly with, in close proximity to, or integrated as part of the processor 133. The system 131 copies data from the memory 134 and/or the storage device 137 to the cache for quick access by the processor 133. In this way, the cache provides a performance boost that avoids processor 133 delays while waiting for data. These and other modules can control or be configured to control the processor 133 to perform various actions. Other system memory 134 may be available for use as well. The memory 134 can include multiple different types of memory with different performance characteristics. It can be appreciated that the disclosure may operate on a computing device with more than one processor 133 or on a group or cluster of computing devices networked together to provide greater processing capability. The processor 133 can include any general purpose processor and a hardware module or software module, such as module-1 138, module-2 139, and module-3 140 stored in storage device 137, configured to control the processor 133 as well as a special-purpose processor where software instructions are incorporated into the actual processor design. The processor 133 may essentially be a completely self-contained computing system, containing multiple cores or processors, a bus, memory controller, cache, etc. A multi-core processor may be symmetric or asymmetric.

The system bus 132 may be any of several types of bus structures including a memory bus or memory controller, a peripheral bus, and a local bus using any of a variety of bus architectures. A basic input/output (BIOS) stored in ROM 135 or the like, may provide the basic routine that helps to transfer information between elements within the system 131, such as during start-up. The system 131 can also include storage devices 137 such as a hard disk drive, a magnetic disk drive, an optical disk drive, tape drive or the like. The storage device 137 can include software modules 138, 139, 140 for controlling the processor 133. Other hardware or software modules are contemplated. The storage device 137 is connected to the system bus 132 by a drive interface. The drives and the associated computer-readable storage media provide nonvolatile storage of computer-readable instructions, data structures, program modules and other data for the system 131. In one aspect, a hardware module that performs a particular function includes the software component stored in a tangible computer-readable storage medium in connection with the necessary hardware components, such as the processor 133, bus 132, display 142, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of computing device that the system 131 is implemented, such as whether the computing device is a small, handheld computing device, a desktop computer, or a computer server.

Although the exemplary embodiment described herein employs the hard disk 137, other types of computer-readable media which can store data that are accessible by a computer, such as magnetic cassettes, flash memory cards, digital versatile disks, cartridges, random access memories (RAMs) 136, and read-only memory (ROM) 135, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 131, an input device 141 represents any number of input mechanisms, such as a microphone for speech, a touch-sensitive screen for gesture or graphical input, keyboard, mouse, motion input, speech and so forth. An output device 142 can also be one or more of a number of output mechanisms known to those of skill in the art. In some instances, multimodal systems enable a user to provide multiple types of input to communicate with the computing device 131. The communications interface 143 generally governs and manages the user input and system output. There is no restriction on operating on any particular hardware arrangement and therefore the basic features here may easily be substituted for improved hardware or firmware arrangements as they are developed.

From the foregoing description, one skilled in the art can readily ascertain the essential characteristics of the invention, and without departing from the spirit and scope thereof, can make changes and modifications of the invention to adapt it to various conditions and to utilize the present invention to its fullest extent. The specific embodiments described here are to be construed as merely illustrative, and not limiting of the scope of the invention in any way whatsoever. Moreover, features described in connection with one embodiment of the invention may be used in conjunction with other embodiments, even if not explicitly stated above.

The steps outlined herein are exemplary and can be implemented in any combination thereof, including combinations that exclude, add, or modify certain steps.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A primary unmanned aerial vehicle for managing traffic flow, comprising:
a processor;
a memory in communication with the processor; and
one or more sensors in communication with the processor and the memory,
wherein the one or more sensors detect a secondary unmanned aerial vehicle approaching the primary unmanned aerial vehicle within a predetermined distance of the primary unmanned aerial vehicle,
wherein the one or more sensors create an area of coverage entirely surrounding the primary unmanned aerial vehicle that the secondary unmanned aerial vehicle is prohibiting from entering,
wherein the processor determines a route of the primary unmanned aerial vehicle to a geographical location based on a signal received from the one or more sensors, the signal indicating the secondary unmanned aerial vehicle has entered the area of coverage entirely surrounding primary unmanned aerial vehicle,
wherein the one or more sensors includes a light sensor which detects a light emitting from the secondary unmanned aerial vehicle, and wherein the processor determines the route of the primary unmanned aerial vehicle to the geographical location based on the light emitting from the secondary unmanned aerial vehicle, and
wherein a size of the area of coverage surrounding the primary unmanned aerial vehicle is based on a particular wavelength of light emitted from the secondary unmanned aerial vehicle.

2. The primary unmanned aerial vehicle of claim 1, wherein the processor determines the route to the geographical location independent from a central system capable of managing the primary unmanned aerial vehicle.

3. (canceled)

4. The primary unmanned aerial vehicle of claim 1, wherein the light emitting from the secondary unmanned aerial vehicle is undetectable to a human eye.

5. The primary unmanned aerial vehicle of claim 1, wherein the light emitting from the secondary unmanned aerial vehicle is detectable to a human eye.

6. The primary unmanned aerial vehicle of claim 1, wherein the one more sensors also includes a sound sensor which detects a sound emitting from the secondary unmanned aerial vehicle, and wherein the processor determines the route of the primary unmanned aerial vehicle to the geographical location further based on both of the light and the sound emitting from the secondary unmanned aerial vehicle.

7. The primary unmanned aerial vehicle of claim 1, wherein the light sensor detects varying wavelengths.

8. The primary unmanned aerial vehicle of claim 7, wherein the varying wavelengths represent at least two of: a location of the secondary unmanned aerial vehicle with respect to the primary unmanned aerial vehicle, a direction by which the secondary unmanned aerial vehicle is approaching the primary unmanned aerial vehicle, a velocity of the secondary unmanned aerial vehicle, and a distance the secondary unmanned aerial vehicle.

9. The primary unmanned aerial vehicle of claim 7, wherein the varying wavelengths are within a predetermined range.

10. The primary unmanned aerial vehicle of claim 9, wherein the predetermined range is dynamically adjusted.

11. (canceled)

12. The primary unmanned aerial vehicle of claim 1, wherein a size of the area of coverage surrounding the primary unmanned aerial vehicle is based on I∝1/d².

13. The primary unmanned aerial vehicle of claim 1, wherein the memory stores one or more rules for flying in a swarm or flying to the geographical location.

14. The primary unmanned aerial vehicle of claim 1, wherein the one or more sensors includes at least three sensors situated at different places of the primary unmanned aerial vehicle.

15. The primary unmanned aerial vehicle of claim 14, wherein each of the three sensors create a partial area of coverage surrounding only a portion of the primary unmanned aerial vehicle.

16. The primary unmanned aerial vehicle of claim 1, additionally comprising:
one or more lights transmitting at distinct wavelengths.

17. The primary unmanned aerial vehicle of claim 1, additionally comprising:
a transponder communicating with the secondary unmanned aerial vehicle.

18. (canceled)

19. (canceled)

20. (canceled)
